(19) United States
(12) Patent Application Publication
(10) Pub. No.: US 2007/0282740 A1
(43) Pub. Date: Dec. 6, 2007

(54) Electronic funds card

(76) Inventor: Bradley W. Wendt, Weston, FL (US)

Correspondence Address: FACTOR & LAKE, LTD, 1327 W. WASHINGTON BLVD., SUITE 5G/H, CHICAGO, IL, 60607, US

(21) Appl. No.: 11/799,756

(22) Filed: May 2, 2007

Related U.S. Application Data
(60) Provisional application No. 60/798,227, filed on May 5, 2006.

(51) Int. Cl. G06Q 40/00; G06Q 30/00

(52) U.S. Cl. 705/39

(57) ABSTRACT

The present invention provides a system and method for facilitating a second party account with employer merchant or sponsor control of one or more spending limits. An exemplary system facilitates provision of funds to a second party and control of the spending of second party by an employer or sponsor through establishment or modification of one or more spending limits. Exemplary spending limits may be configured for modifying a spending capacity so as to affect, for example, amount per transaction, per day, during a predetermined time period, at a particular merchant, at a particular chain of merchants, at a type of industry, in accordance with a predetermined rate of increase or decrease over time, number of transactions during any time period and/or any combination thereof. All unspent monies to include but not limited to cash, credit, goods, services, award points and consumer experiences are returned to the first party.

### RELATED APPLICATIONS

This application claims the benefit of U.S. Provisional Application Ser. No. 60/798,227, filed May 5, 2006.

### FIELD OF THE INVENTION

The present invention relates generally to systems for facilitating transactions, and more specifically to systems for facilitating financial services at the request of a first party for the use of a second party such that the first party may define, modify, and/or terminate the spending capacity accorded the second party and wherein all unspent monies by the second party are returned to the first party.

### BACKGROUND OF THE INVENTION

As contemplated by the inventor, it would be advantageous to have a financial vehicle that would enable a first party (e.g., employer) to provide value to be spent by a second party (e.g., employee), while providing control over the spending capacity and/or debt accumulation by the second party. It would also be advantageous if such control included the ability to limit total spending or to prevent or limit spending for specific classes of goods and/or services or to limit or prevent spending at specific classes of merchants or service providers or to limit or prevent spending at specifically identified merchants or service providers. Moreover, it would be advantageous for such a card to not enable carryover of a credit, debit or prepaid balance, and instead transfer any credit, debit or prepaid balance back to the first party.

### SUMMARY OF THE INVENTION

The present invention provides a flexible limit subsidiary card account that may enable a first party to easily and flexibly control the spending capacity of a subsidiary account. In particular, the invention is directed towards a system and method that allows a first party to provide funds to a subsidiary and to at least partially control the second party's spending capacity. In a first aspect, a system for administering a subsidiary card account includes a primary or parent and an administrator. The parent, which can be associated with an established credit instrument, e.g., a primary or parent account, is configured to communicate a request for a subsidiary account to be established and associated with a subsidiary. The administrator is configured to receive the request from the parent and to facilitate the establishment and issuance of a subsidiary account. The administrator is also configured to facilitate determination and adjustment of appropriate spending power and capacity for the subsidiary account in accordance with instructions of the first party.

The instructions may be configured so as to impose one or more desired spending limits upon the second party through the subsidiary account. Limits and/or restrictions may include, for example, charge amount per charge, charge amount per day or date, charge amount during any time period, charge amount at a particular merchant, charge amount at a particular chain of merchants, charge amount at a type of industry, increasing or decreasing charge amount limits over time, limit on number of transactions during any time period and/or any combination thereof. The limitations may also include, for example, any one or more of type of authorized transaction, one of a good and a service authorized, authorized one of vendor, store, and service provider, transaction amount limitation, daily spending limit, authorized geographical area of usage, authorized time of usage, authorized individual, transaction limit for one of a savings account, a checking account, a bank account, and an automated teller machine account, authorized individual for transacting on a savings account, a checking account, a bank account, and an automated teller machine account, proof of identity required for transaction, one of bank and financial institution authorized for the transaction, a limitation of a fee charge on an account, automated teller machine account access code, authorized transaction location, authorized telephone number, authorized telephone calling time, authorized telephone calling area, authorized telephone calling destination, authorized number of telephone calls, authorized incoming telephone call, authorized telephone call duration, and/or authorized telephone call cost and/or transaction amount.

Further, any authorized monies not spent within one or more desired spending limits will be returned to the primary or parent account. Monies may incorporate cash, goods, services, benefits, credit, and/or consumer experiences.

These and other features and advantages of the invention will be more readily apparent upon reading the following description of the preferred embodiment of the invention and upon reference to the accompanying drawings wherein:

### BRIEF DESCRIPTION OF THE DRAWINGS

The above-mentioned objects and features of the present invention can be more clearly understood from the following detailed description considered in conjunction with the following drawings, in which like numerals represent like elements and in which:

FIG. 1 illustrates the interactions of an exemplary system configured to administer a flexible limit subsidiary card account; and,

FIG. 2 illustrates an exemplary process for administering a flexible limit subsidiary card account.

While the invention is susceptible of various modifications and alternative constructions, certain illustrated embodiments hereof have been shown in the drawings and will be described below. It should be understood, however, that there is no intention to limit the invention to the specific forms disclosed, but, on the contrary, the invention is to cover all modifications, alternative constructions and equivalents falling within the spirit and scope of the invention as defined by the appended claims.

### DESCRIPTION OF THE PREFERRED EMBODIMENTS

The present invention is a payment and funding vehicle that is configured to allow a first party and an administrator to provide funds in the form of a credit line (i.e., spending capacity) to a second party. The system thereby facilitates control over the second party's spending capacity and/or debt accumulation. In accordance with one aspect of the invention, a system for administering a subsidiary card account includes a first party and an administrator. The first party, which is responsible for a related credit instrument, e.g., a primary account, is configured to communicate a request to the administrator requesting that a credit, debit, checking or prepaid card account be issued to a second party. The administrator is configured to receive the request from the first party and to facilitate the establishment and administration of the subsidiary card account so that it may be used by the second party to facilitate transactions. The administrator can, but not necessarily, also be configured to facilitate determination and adjustment of appropriate spending power for the subsidiary account and spending capacity for the subsidiary card account in accordance with instructions of the first party. Further, any authorized monies not spent within one or more desired spending limits and period will be returned to the primary or parent account.

Instructions may be configured for modifying a spending capacity under specific predefined circumstances so as to impose one or more desired spending limits upon the second party through the subsidiary account. Limits and/or restrictions may include, for example, charge amount per charge, charge amount per day or date, charge amount during any time period, charge amount at a particular merchant, charge amount at a particular chain of merchants, charge amount at a type of industry, increasing or decreasing charge amount limits over time, limit on number of transactions during any time period and/or any combination thereof. The limitations may also include, for example, any one or more of type of authorized transaction, one of a good and a service authorized, authorized one of vendor, store, and service provider, transaction amount limitation, daily spending limit, authorized geographical area of usage, authorized time of usage, authorized individual, transaction limit for one of a savings account, a checking account, a bank account, and an automated teller machine account, authorized individual for transacting on a savings account, a checking account, a bank account, and an automated teller machine account, proof of identity required for transaction, one of bank and financial institution authorized for the transaction, a limitation of a fee charge on an account, automated teller machine account access code, authorized transaction location, authorized telephone number, authorized telephone calling time, authorized telephone calling area, authorized telephone calling destination, authorized number of telephone calls, authorized incoming telephone call, authorized telephone call duration, and/or authorized telephone call one of cost and transaction amount.

In accordance with an embodiment of the invention, a system may enable a first party to limit its risk by facilitating establishment and/or modification of one or more spending limits. Accordingly, such limits may be configured to reduce potential imposition of liability on the first party in the event that a second party uses a second party account in violation of one or more established spending limits (i.e., makes “unauthorized” charges). Merchant may be able to have the system authorize all expenditure forms.

As used herein, the terms “first party,” “parent,” and “primarily” refers to one or more parties possessing one or more existing credit vehicles, such as credit card accounts, and/or any other payment or transaction device and desiring to establish, and at least partially accept responsibility for, one or more credit line or other financial commitment system to be used by at least one other party. It should be noted that a first party may be a company, entity, guardian and/or any other party which provides credit or payment for a second party. Also, as used herein, the term “second party” refers to one or more recipient of a credit or other payment line established at the request of a first party. It should be noted that a second party may be any person, entity, and/or other party capable of receiving and using a credit line provided by a first party and may be an employee, entity, dependant child or any other party capable of receiving a credit line or any other payment arrangement.

In accordance with the present invention, an account held by a second party (e.g., a second party or subsidiary card account) facilitates transactions by allowing the second party to access credit. It should be noted that the second party card account may be substantially a credit vehicle. As such, it may not require substantial pre-payment, neither by a first party nor a second party. However, in an embodiment, the second party card account can be a credit vehicle such a debit or prepaid card, requiring pre-payment be a first party or a second party, or pre-authorization by a first party. Moreover, a first party or second party card account may include an account code associated with a physical card or simply an account code without a physical card for example a checking account with paper checks.

It should be noted that, as used herein, the term “administrator” refers to all types of credit, debit, checking or prepaid issuing institutions, such as banks, credit card companies, card sponsoring companies, governmental agencies or third party issuers under contract with financial institutions. It should also be noted that other participants may be involved in some phases of transactions related to facilitation of transactions involving the accounts, such as one or more intermediary settlement institution, but these participants are not shown.

An “account number,” as used herein, includes any device, code, or other identifier and/or indicia suitably configured to allow a consumer to interact or communicate with the system, such as, for example, an authorization/access code, a personal identification number (PIN), an Internet code, other identification code, and/or the like which may optionally located on a rewards or incentives card, charge card, credit card, debit card, prepaid card, telephone card, smart card, magnetic stripe card, bar code card, check stock electronic ink and/or the like. Such an account number may be distributed and stored in any form of plastic, electronic, magnetic, paper and/or optical device capable of transmitting or downloading data from itself to a second device. A second party or first party account number may be, for example, a multi-digit credit issuer's identifier such as a credit, debit or prepaid card number.

Although described in terms of a card account, the invention may represent a complete payment service encompassing all involved processes from authentication of the participants to authorization of the transaction to settlement of the payment. The flexible limit second party card account may be established as virtual account, but can also be offered and distributed as a plastic card to be managed and/or supported by an issuer, and can further be branded for and distributed by a third party. It should be noted that the flexible limit second party card account may be used to facilitate online transactions as well as transactions conducted at storefronts kiosks and turnstyles using plastic that has been distributed for the flexible limit second party card account.

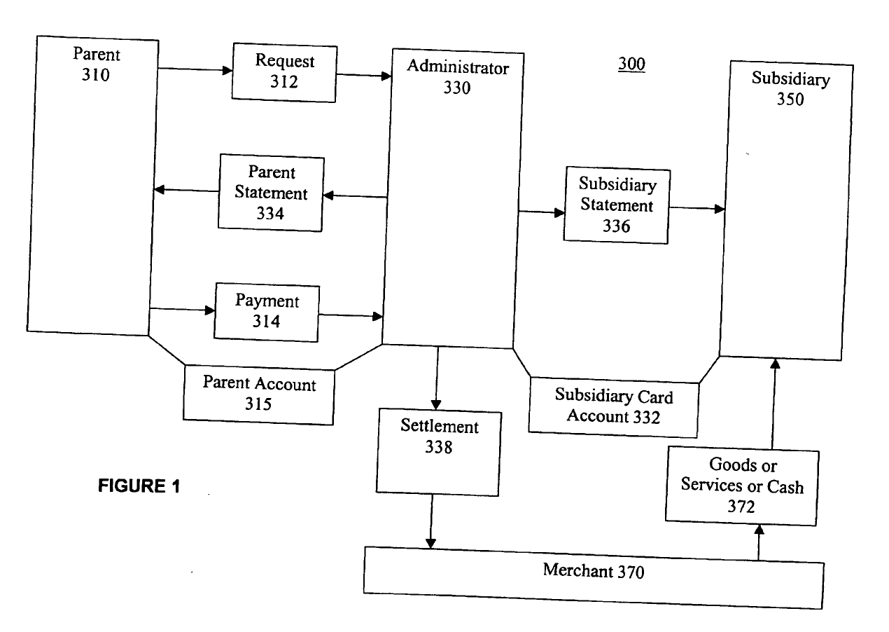

FIG. 1 illustrates the interactions of an exemplary system configured to administer a flexible limit second party card account. In accordance with an exemplary embodiment, the system 300 facilitates interaction between a first party, primary or parent 310, a second party or subsidiary 350 and a merchant 370 through an administrator 330. Parent 310 is responsible for a first party, primary or parent account 315, and is configured to communicate a request 312 to administrator 330 requesting that a second party or subsidiary card account 332 be established for second party or subsidiary 350. Administrator 330 is configured to receive request 312 from parent 310 and to facilitate the establishment and administration of a second party or subsidiary card account 332 so that it may be used by subsidiary 350 to facilitate transactions.

In an exemplary embodiment, the system of the present invention enables parent 310 to provide one or more second party or subsidiary accounts 332, each being related to the first party, primary or parent account 315. In other words, subsidiary account 332 may comprise one or more accounts that may each be linked to the parent account 315. It should also be noted that parent account 315 may represent one or more accounts sharing responsibility for subsidiary card account 332. Similarly, subsidiary 350 may comprise a corresponding number of subsidiaries, each being the beneficiary of one or more subsidiary card account 332. Accordingly, the system of the present invention may enable a corporation to provide for many employees and similarly may enable a guardian to provide for many dependents.

In an exemplary embodiment, the flexible limit subsidiary or second party card account system 300 is implemented as computer software modules loaded onto the computer of first party or parent 310, the computer of administrator 330, the computer of second party or subsidiary 350, and/or the computer of a merchant 370.

The system 300 may include a host server or other computing systems including a processor for processing and encrypting digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including data regarding the first party or parent account 315, second party or subsidiary 350 data, merchant 370 data, financial institution data and/or like data that could be used in association with the present invention. The host may be a remotely located system or the host may be a processor located on a smart account. The limitations or restrictions may be communicated to a host via any network, email, webpage, voice response unit or customer service line via customer service representatives. The limitations or restrictions may also be transmitted to the host via one or more of a telephone, a touch-tone telephone, a two-way pager, a reply pager, a home computer, a personal computer, a personal communication device, a personal communication services device, a digital communications device, a television, an interactive television, a digital television, a personal digital assistant, a display telephone, a video telephone, a watch, a cellular telephone, a wireless telephone, a mobile telephone, a display cellular telephone device connected to airwaves, and a facsimile machine.

As those skilled in the art will appreciate, the computer of first party or parent 310 and, if desired, second party or subsidiary computer will typically include an operating system (e.g., Windows NT, 95/98/2000, Linux, Solaris, etc.) as well as various conventional support software and drivers typically associated with computers. The invention, however, could also be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris or the like. Moreover, although the invention may be implemented with TCP/IP communications protocols, it will be readily understood that the invention could also be implemented using IPX, Appletalk, IP-6, NetBIOS, OSI or any number of existing or future protocols. The system contemplates the use, sale or distribution of any goods, services or information over any network having similar functionality described herein. Computers can be in a home or business environment with access to a network. In an exemplary embodiment, access is through the Internet through a commercially-available web-browser software package.

Database may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access by Microsoft Corporation (Redmond, Wash.), or any other database product. Database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

Communication between the parties and the system of the present invention is accomplished through any suitable communication means, such as, for example, a telephone or telephone network, a touch-tone telephone, a two-way pager, a reply pager, a home computer, a personal computer, a personal communication device, a personal communication services device, a digital communications device, a television, an interactive television, a digital television, a personal digital assistant, a display telephone, a video telephone, a watch, a cellular telephone, a wireless telephone, a mobile telephone, a display cellular telephone, a facsimile machine, Intranet, Internet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

To simplify the description of the invention herein, various embodiments of the invention is may be described as pertaining to a system facilitating communication between a domestic merchant system (or ATM) and a foreign financial institution card issuer using a computer network. It should be appreciated that the computing units may be connected with each other via a data communication network. The network may be a public network and assumed to be insecure and open to eavesdroppers. For example, the network may be embodied as the internet. In this context, the computers may or may not be connected to the internet at all times. For instance, the computer of the first party or parent 310 and/or the computer of second party or subsidiary 350 may employ a modem to occasionally connect to the internet, whereas administrator 330 or bank computing center might maintain a permanent connection to the internet. Specific information related to the protocols, standards, and application software utilized in connection with the Internet may not be discussed herein. For further information regarding such details, see, for example, Dilip Naik, Internet Standards and Protocols (1998); Java 2 Complete, various authors, (Sybex 1999); Deborah Ray and Eric Ray, Mastering HTML 4.0 (1997). Loshin, TCP/IP Clearly Explained (1997). All of these texts are hereby incorporated by reference.

As a further example, the computer of parent 310, the computer of subsidiary 350, the computer of administrator 330, and the computer of merchant 370 may all be interconnected via a network, referred to as a transaction network. The transaction network represents existing proprietary networks that presently accommodate on-line transactions for credit cards, debit cards, checking accounts and other types of financial/banking cards. The payment network is a closed network that is assumed to be secure from eavesdroppers. Examples of the payment network include the American Express.RTM., VisaNet.RTM. and the Veriphone.RTM. network.

The American Clearing House Associate, Federal Reserve (“FED ACH”), Electronic Payments Network, and Visa act as ACH Operators, central clearing facilities through which financial institutions transmit or receive ACH entries. The ACHA (American Clearing House Association) is one of the three private sector ACH operators in the United States.

A check that has been converted into an ACH transaction becomes a “truncated check,” or “electronic draft”. These electronic drafts are commonly called “items”, “transactions”, “debits”, “ach's”, and “checks”. Technically, a check that has been converted into an electronic draft is no longer a check; however, colloquially language often still uses the term “check” to describe these transactions.

One skilled in the art will appreciate that the network may include any system for exchanging data or transacting business, such as the Internet, an intranet, an extranet, WAN, LAN, satellite communications, and/or the like. It is noted that the network may be implemented as other types of networks, such as an interactive television (ITV) network. The users may interact with the system via any input device such as a keyboard, mouse, kiosk, personal digital assistant, handheld computer (e.g., Palm Pilot.RTM.), cellular phone and/or the like.

The systems may be suitably coupled to network via data links. A variety of conventional communications media and protocols may be used for data links. Such as, for example, a connection to an Internet Service Provider (ISP) over the local loop as is typically used in connection with standard modem communication, cable modem, Dish networks, ISDN, Digital Subscriber Line (DSL), or various wireless communication methods. Merchant 370 system might also reside within a local area network (LAN) which interfaces to network via a leased line (T1, D3, etc.). Such communication methods are well known in the art, and are covered in a variety of standard texts. See, e.g., Gilbert Held, Understanding Data Communications (1996), hereby incorporated by reference.

In on-line implementations of the instant invention, each participant is equipped with a computing system. First party or parent 310 may be equipped with a computing unit in the form of a personal computer, although other types of computing units may be used including laptops, notebooks, hand held computers, set-top boxes, and the like. Administrator 330 may be equipped with a computing unit such as a computer-server, although other implementations are possible. Second party or subsidiary 350 and merchant 370 each may be implemented as a computer, which may be a main frame computer or which may be implemented in other forms, such as mini-computers, PC servers, a network set of computers, and the like.

The computer may provide a suitable website or other Internet-based graphical user interface which is accessible by users. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access Sequel Server, Oracle, MySQL, Intervase, etc., may be used to provide an ADO-compliant database management system. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

In an exemplary embodiment, the system of the present invention facilitates administration of a second party or subsidiary card account 332 so that it may function with many of the features and characteristics of traditional credit, debit or prepaid cards. For example, second party or subsidiary card account 332 may be configured to be used at an ATM or at a point of sale and can also be configured to provide security and protection through traditional insurance features. Moreover, second party or subsidiary card account 332 may be configured to satisfy most if not all standard credit, debit or prepaid card requirements such as embossing of the identifying information (e.g., name, account number, expiration date, signature, and the like) of first party or parent 310 and second party or subsidiary 350.

In addition, the flexible limit subsidiary card account system can accommodate the requirements of the underlying dependent financial instruments. If there are usage restrictions or limitations in place for the first party or parent account 315, those same controls (if known) may be enforced by flexible limit second party or subsidiary card account 332. For example, if second party or subsidiary card account 332 is to be restricted to use at only restricted merchants 370, then the system will disable second party or subsidiary card account 332 from being used at any non-approved merchant 370.

Similarly, a second party or subsidiary card account may be configured to accommodate emergency conditions such as an emergency needs for medical care, pharmaceuticals, transportation, or the like. Accordingly, second party or subsidiary card account may be configured to bear an extended spending capacity available for use at specific merchants (e.g., a specified hospital, pharmacy, or travel agent) or specified classes of merchants (e.g., medical service providers, pharmacies, or travel agencies in general). Optionally, a second party or subsidiary card may be configured to accommodate anticipated expenditures that may occur only periodically, such as rent payments or lodging. In accordance with this embodiment, spending capacity may be reserved to accommodate payment for the anticipated expenditures even if spending capacity for other expenditures (e.g., entertainment) may have been exhausted.

In an exemplary embodiment, one or more cash advance limits may be prescribed by a first party and configured so as to enable the first party to choose to give the second party accountholder access to cash advances at ATM'S. In another exemplary embodiment, one or more account usage limits may be prescribed by a first party and configured so as to enable the first party to choose to give the second party accountholder the ability to use the account in one or more predefined locations whereby if a purchase or cash advance limit is exceeded, an attempted transaction may be declined. The limits or restrictions may include, for example, charge amount per charge, charge amount per day, charge amount during any time period, charge amount at a particular merchant, charge amount at a particular chain of merchants, charge amount at a type of industry, increasing or decreasing charge amount limits over time, limit on number of transactions during any time period and/or any combination thereof. The limitations may also include, for example, any one or more of type of authorized transaction, one of a good and a service authorized, authorized one of vendor, store, and service provider, transaction amount limitation, daily spending limit, authorized geographical area of usage, authorized time of usage, authorized individual, transaction limit for one of a savings account, a checking account, a bank account, and an automated teller machine account, authorized individual for transacting on a savings account, a checking account, a bank account, and an automated teller machine account, proof of identity required for transaction, one of bank and financial institution authorized for the transaction, a limitation of a fee charge on an account, merchant, automated teller machine account access code, authorized transaction location, authorized telephone number, authorized telephone calling time, authorized telephone calling area, authorized telephone calling destination, authorized number of telephone calls, authorized incoming telephone call, authorized telephone call duration, authorized telephone call cost and transaction amount.

Limitations or restrictions may be communicated to a host via any network, email, webpage, voice response unit or customer service line via customer service representatives. The limitations or restrictions may also be transmitted, directly or indirectly, to the host via one or more of a telephone, a touch-tone telephone, a two-way pager, a reply pager, a home computer, a personal computer, a personal communication device, a personal communication services device, a digital communications device, merchant communication device, a television, an interactive television, a digital television, a personal digital assistant, a display telephone, a video telephone, a watch, a cellular telephone, a wireless telephone, a mobile telephone, a display cellular telephone, a facsimile machine or as otherwise describe herein or known in the art.

In an exemplary embodiment, the system may be configured to allow a first party or parent to set, review and re-set purchase limits and cash advance limits associated with one or more individual second party or subsidiary accounts via a suitable means for communicating as described herein. In addition, an exemplary system and method may facilitate systematic checking to validate a request (e.g. validate a requested limit relative to a shadow line associated with the first party account), prior to updating a limit associated with a second party account. In one embodiment, new limits and/or validated changes to existing limits may be facilitated in substantially real-time. In an alternative embodiment, however, such changes may be applied at pre-determined times or intervals or in a batch mode.

In one embodiment, a maximum limit on a second party or subsidiary account may be determined by an overall exposure associated with the account so as to prevent total spending between the first party or parent account and its associated second party accounts from exceeding a predetermined amount (e.g., $1000). For example, in accordance with this embodiment, a system may facilitate spending by a second party to the extent of $1000 every cycle (e.g., month); however, the ability of the second party to charge up to that predefined $1000 may depend on whether a sufficient spending power exists with respect to the first party account.

In alternative embodiments, limits, restrictions or any other progress toward the limits may be displayed. Membership fees for both the basic accountholder and second party, may be billed annually. In an alternative embodiment, the membership or any other fees may be billed at any interval.

With further reference to FIG. 1, in an embodiment, administrator 330 is configured to facilitate determination and adjustment of appropriate spending powers for the first party or parent account 315 and second party or subsidiary card account 332 in accordance with a predetermined set of rules. An exemplary set of rules configured to accommodate the provision of a credit line to a second party or subsidiary 350 may require an allocation of risk between administrator 330 and first party or parent 310 whereby the spending power of the first party account 315 is reduced by an amount that is less than the spending capacity or credit line established for related second party card account 332, in accordance with, and reflecting, an allocation of risk accepted by administrator 330. Similarly, the system 300 may include a similar set of rules and be configured to accommodate a reduction in an existing spending capacity that previously had been provided to a second party 350. For example, the spending power of the first party account 315 may be increased by an amount that is less than the reduction in the spending capacity for the related second party card account 332.

It should also be noted, however, that specific embodiments of the invention may be configured to accommodate local customs and/or practices or to accord with applicable legal requirements. The details of how the spending capacity of the first party or parent card is consumed as the spending capacity of each second party or subsidiary card is increased and/or consumed will depend, of course, on regulatory and practical considerations applicable wherever and however the cards are used and their functions facilitated. In addition, the administrator may be configured to allocate payment liability to lie entirely with the holder of the first party or parent card so as to eliminates the risk of uncollectability associated with second party or subsidiary cards in situation such as where the second party card is held by a minor or otherwise not legally responsible party. The details of how the responsibility and or liability for spending capacity consumed by the second party card and/or received by the merchant may be determined to satisfy various regulatory and/or practical considerations applicable wherever and however the cards are used and their functions facilitated.

As discussed herein, an administrator 330 may issue a second party or subsidiary card account 332 that bears its own spending capacity, i.e., a second party spending capacity, and that is linked to a first party or parent account 315. As described herein, the system of the present invention enables first party or parent 310 to define and change the spending capacities (e.g., credit limits or other mechanisms for approving or denying an individual transaction) for each second party or subsidiary card account 332 or to cancel one or more second party card account 332 altogether. To accommodate the access of second party card account 332 to the second party spending capacity, the original spending power of a first party account 315 is reduced to a modified first party spending power. The difference between the original first party spending power and the modified first party spending power, however, may be less than the second party spending capacity in cases where some of the risk associated with second party card account 332 is assumed by administrator 330. In other words, the sum of the modified first party spending power and the second party spending capacity may be greater than the original first party spending power, the difference being equal to the risk assumed by administrator 330. For example, an original spending power of a first party account 315 set at $9500 may be reduced to $9000 when an administrator 330 issues a second party card account 332 linked to the first party account 315, but the second party card account 332 will have a spending capacity of $1000. In this case, the original spending power of the first party account 315 is decreased by $500 while administrator 330 assumes $500 of risk. Thus, the total spending power for the first party account 315 and the second party card account 332 increases from $9500 to $10000.

It should be noted that the invention contemplates that there may be one or more first party or parent card representing the first party and associated with which there may also be one or more second party or subsidiary card. It should also be noted that each second party card may have associated with it one or more spending schemes, whereby a spending limit associated with first second party card may be different from a spending limit associated with a second second party card even though both second party card accounts are associated with the same first party.

In an exemplary embodiment, a spending capacity may be prescribed in terms of one or more currency (e.g., an amount in U.S. dollars, an amount in Japanese yen) and may also be prescribed as a minimum or maximum of amounts described in terms of two or more currencies. For example, in an exemplary embodiment, a spending capacity is described as an amount in Japanese yen so long as that amount is greater than an amount in U.S. dollars. In another exemplary embodiment, a spending capacity is described as an amount in Japanese yen so long as that amount does not exceed an amount in U.S. dollars.

In an exemplary embodiment, a spending capacity may be variable and may be determined according to one or more factors. Exemplary factors may include, one or more currency exchange rates, an age of a second party card holder, a standard cost of living indicator (e.g., consumer price index), the current date, the length of time elapsed from a predetermined date, or the like. In accordance with this embodiment, a spending capacity may be determined, and subsequently re-determined, so as to provide a fixed spending capacity (e.g., $500 per month) in terms of a first currency (e.g., U.S. dollars) for a first period of time and then modified so as to provide a revised spending capacity (e.g., .Yen. 100,000 per month) in terms of a second currency (e.g., Japanese yen) for a second period of time (e.g., three months). Accordingly, a second party card may be preconfigured to accommodate the spending of a second party as the subsidiaries spending needs change (e.g., as an employee traveling abroad). Spending capacity for goods and services will likewise take into account these factors and all other factors effecting price.

In addition, where anticipated future expenditures (e.g., car rental or hotel rental) are defined in terms of a first currency (e.g., British pounds) a spending capacity of a second party card may be provided so as to accommodate the anticipated expenditures even though the first party card from which the spending capacity is acquired may be depleted in terms of a second currency (e.g., U.S. dollars). Put another way, the system may optionally be configured to provide the ability for first party to eliminate risks associated with fluctuations in currency exchange rates by committing to fixed automatic long-term charges at a fixed foreign exchange rate for a fixed term. In addition, the system and method of the instant invention may provide the ability to fix the currency exchange rate so as to eliminate, from the perspective of the holder of the first party card, any risk associated with fluctuations in currency exchange rates while, for example, a second party is consuming spending capacity in a currency that is different from the currency used by the holder of the first party card to provide the spending capacity to the second party.

In an exemplary embodiment, a spending capacity of first party card account may be periodically decreased by a predetermined amount while the spending capacity of the second party card account is increased by a substantially equivalent amount, such that the second party card account functions substantially as a pre-paid card account. Alternatively, the spending capacity of first party card account may be periodically decreased by an amount substantially equivalent to the spending capacity consumed by the second party card account, such that the second party card account functions as a credit card linked to the first party card account.

In an exemplary embodiment, a first party may communicate a request to the system to request cancellation, closure or temporary disablement of one or more second party accounts, and, in response, an exemplary system may be configured to accommodate such a request by accordingly facilitating cancellation, closure or temporary disablement of the appropriate second party accounts. For example, a first party may call a telephone number or access a website that may be listed on the back of a transaction card associated with a first party account or a second party account and may request to cancel a second party account. In the event that there is only one second party account, then the system may facilitate the first party's choice to cancel the second party account via a voice recognition system (i.e. the system may not require the first party to interface with a customer service representative). However, if the first party has multiple second party accounts associated with their first party account, the system may, in one embodiment, include additional processing to determine which of the first party's associated second party accounts the first party wishes to be modified (e.g., cancelled or otherwise modified). Such additional processing may entail additional automated steps configured to determine the required information or may simply entail connection of the first party to a customer service representative.

In an exemplary embodiment the spending power associated with a first party account is not affected by the spending capacity granted to a second party account. In accordance with this embodiment, the system may be configured to facilitate consideration of the spending capacity associated with the second party account when determining whether or not to authorize a transaction through the first party account. Alternatively, an exemplary system may be configured so that the existence of a limit associated with a second party account will not change the first party's ability to spend in the event that the second party is not consuming its spending capacity.

With further reference to FIG. 1, an exemplary administrator 330 may be configured to establish more than one second party or subsidiary card account 332 at the request of first party or parent 310, and each second party or subsidiary card account 332 may bear a different credit line than either the first party or parent account 315 or any other second party or subsidiary card account 332. In addition, an exemplary administrator may receive, and facilitate execution of, a request from first party or parent 310 to define, modify, and/or terminate the spending capacity and/or debt accumulation limit for second party or subsidiary card account 332 (e.g., $500.00 spending capacity for a first second party or subsidiary card account 332, $800.00 spending capacity for a second second party or subsidiary card account 332, and $250.00 spending capacity for a third second party or subsidiary card account 332) and/or modified by first party or parent 310.

In accordance with an exemplary embodiment, the system may also be configured to prevent carry-over of credit from one month to the next. In accordance with this embodiment, transactions facilitated by second party or subsidiary card account 332 are permitted until a pre-set spending capacity has been consumed. For example, in an exemplary embodiment, administrator 330 tracks the transactions facilitated by the second party or subsidiary card account 332 to maintain a current account status. Whenever authorization for a particular transaction is requested of the administrator 330, the administrator 330 compares the status that would exist if the transaction were authorized and completed against the permissible status based upon a predetermined set of criteria (e.g., credit line, spending capacity, payment status, creditworthiness). Thus, when the transactions facilitated by a second party or subsidiary card account 332 have reached the spending capacity, or would cause the spending capacity to be exceeded within the predetermined time period, or otherwise violate the predetermined set of criteria, no more charges will be authorized. In accordance with this embodiment, at each cycle cut, available credit is re-set to the pre-defined spending capacity. Thus, in accordance with this embodiment, unused spending capacity from one cycle cannot be used during the following cycle. In the event that the card is configured to accommodate emergency transactions as described herein, however, emergency transactions may be permitted without consuming spending capacity.

Alternatively, the system may be configured to permit carry-over and accumulation of spending capacity from one month or designated time period to the next. In this embodiment, at the beginning of each cycle cut, additional spending capacity may be added to second party or subsidiary card account 332. In accordance with this embodiment, unused spending capacity from one cycle can be used in subsequent cycles and may be accumulated. In the event that carry over capacity is permitted, the carry over risk is allocated between the first party or parent 310 and the administrator 330 in accordance with a predetermined set of criteria as described above. In accordance with this embodiment, interest may be credited for unused spending capacity.

With respect to applications and account settling, administrator 330 may require both first party or parent 310 and prospective second party or subsidiary 350 to apply for the second party or subsidiary card account 332. Administrator 330 may require information regarding first party or parent 310 to assess qualification for the second party or subsidiary card account 332 (credit history, salary, etc.). Administrator 330 may also require information regarding second party 350 to qualify for a minimum age requirement, not valid after specified date, to provide information to be embossed on the card, and to provide identification information (e.g., social security number, mother's maiden name, etc.). In addition, administrator 330 may define a maximum pre-set spending capacity, limit, or budget based upon an assessment of the first party's 310 creditworthiness, and subject to a predetermined maximum amount.

It should be noted that the system 300 may at times require acquisition or verification of the identity of first party or parent 310 or second party or subsidiary 350. Administrator 330 may accomplish the process of obtaining and/or verifying the identity of first party 310 or second party 350 through a variety of means that are known in the art including, but not limited to, use of private databases, credit bureau databases, transmission of biometric data, transmission of “handshake” data (i.e., smart card signature, challenge/response, etc) and/or the like. Thus, the authentication information is collected for the purpose of establishing the second party card account 332 and defining its ownership. It should be noted that, although the instant invention may be embodied as a microchip enabled device, it may also be configured as a virtual and not a physical (e.g., plastic) account, which may not accommodate a microchip.

In accordance with the present invention, an exemplary system is configured to facilitate communication between first party or parent 310, a second party or subsidiary 350, and an administrator 330 regarding the status (e.g., transactions, accrued interest, balances, available credit, payments, billings, etc.) of second party or subsidiary account 332 and a first party or parent account 315. In accordance with an exemplary embodiment, administrator 330 may communicate statements or transaction reports to both first party 310 and second party 350. In an exemplary embodiment, one or more account statement options may be selected by a first party 310 such that paper and/or online statements may be generated listing each second party account's transactions in a separate section. In accordance with an exemplary embodiment, current limit(s) for second party accounts may suppressed so that they may be prevented from being displayed on statements. Accordingly, second party 350 may be enabled to monitor transactions so as to enable second party to dispute charges if necessary. Alternatively, second party may be partially or fully restricted from monitoring transactions depending of the choice of the first party. In addition, administrator 330 may enable first party 310 to monitor the amount of spending capacity consumed by second party 350. As discussed herein, the levels of detail provided in such statements 334 may be configured by first party 310, second party 350, or both. Further, whenever first party 310 has modified the spending capacity of second party card account 332, administrator 330 may be configured to notify second party 350 through second party statement 336. Based upon the first party statement 334, first party 310 may remit payment 314 to administrator 330, or a designee of administrator 330.

Accordingly, an exemplary administrator 330 is configured to generate a first party or parent account statement 334 for the first party or parent account 315. In addition, administrator 330 is configured to dispatch additional statements 336 for each second party or subsidiary card account 332 to each designated second party or subsidiary 350. The second party account statements 336 may be dispatched to individual designated addresses such as the separate addresses of the individual subsidiaries 350. Moreover, administrator 330 is configured to charge, i.e., adjust, the first party account 315 spending power based on the spending capacity advanced to and consumed by each of the subsidiaries 350. In an exemplary embodiment, the statement 334 provided to first party 310 regarding the activity of each second party 350 is limited to the aggregate sum owed. Alternatively, the statements 334 may include additional information regarding the activities of each second party 350 may be provided depending upon the wishes of first party 310 and/or each second party 350. Administrator 330 may provide various levels of control to first party 310 and/or various levels of independence and privacy to second party 350 through this mechanism. Finally, administrator 330 is configured to manage and track the balances of each first party account 315 and each second party card account 332 in accordance with the activities transacted using each account (e.g., purchases, cash advances, interest accrued, payments made, credit limits modified, spending capacities, receipt of goods and services etc.).

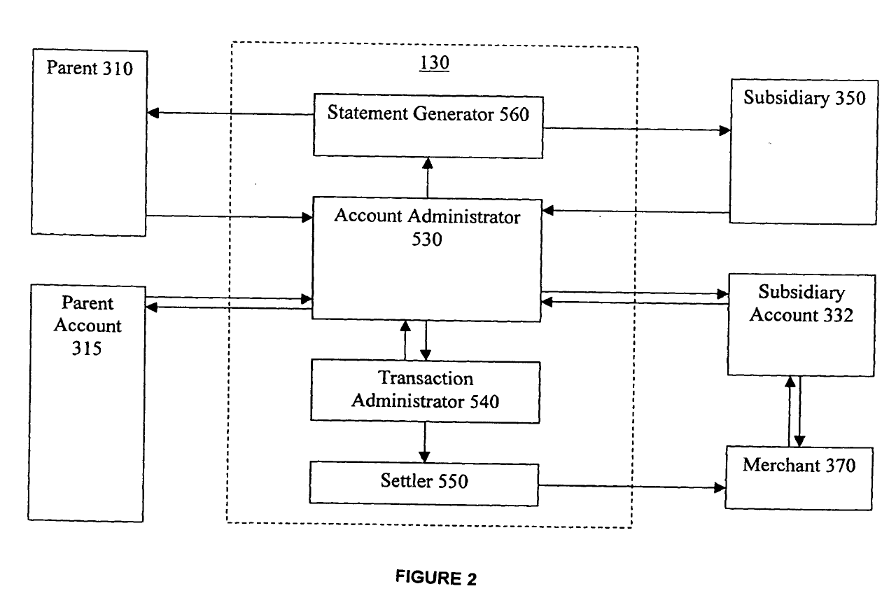

FIG. 2 illustrates an exemplary process for administering a flexible limit second party or subsidiary card account 332. In accordance with this embodiment, a first party or parent 310 submits a request 312, via facsimile, telephone, internet or any other means known in the art, for a second party or subsidiary card account 332 to an agent, delegate, or affiliate of the administrator (step 510). The request 312 may include information sufficient to identify and verify the identity of the first party or parent 310 and the second party ob subsidiary 350 (e.g., name, address, social security number, mother's maiden name, telephone number). The request 312 may also include information necessary to configure a second party card account 332 such as desired spending capacity, credit line, restricted merchants 370 or classes of merchants, emergency enabled merchants or classes of merchants for whom the spending capacity may be extended or waived, and whether carryover is enabled. In response, administrator 330 may approve or refuse the request based upon a predetermined set of criteria such as credit worthiness or payment history of the first party 310 (step 512). If administrator 330 approves the request 312, administrator 330 establishes second party card account 332 and a second party spending capacity (step 514). The second party card account 332 and the first party account 315 are linked in that the first party account 315 remains responsible for transactions facilitated by the second party card account 332 and in that the first party 310 may access account and transaction information related to the second party card account 332. To accommodate the provision of credit to second party 350, administrator 330 decreases the spending power of the first party account 315 in accordance with a predetermined set of rules, for example, by an amount less than the amount of credit provided to second party 350 (step 516). Accordingly, administrator 330 accepts some risk for the extension of credit to second party 350. In the event of non-payment for transactions facilitated by the second party card account, a hold may be placed upon both the first party account 315 and the second party card account 332. Ultimately, the first party 310 is responsible for all transactions facilitated by the second party card account. Finally, administrator 330 dispatches tangible indicia of second party card account 332, such as a plastic card, to second party 350 (step 520).

If approved, the system issues a card to second party 350 as well as a PIN number or other system and method for verifying the identity of, i.e., authenticating, the user at, for example, an ATM. Upon receipt of the card, before use, the system may require the card member to activate second party card account 332 (e.g., sign the card and/or place a telephone call to a predetermined number). Once second party card account 332 has been activated, second party 350 may use the card account 332 throughout the cycle period to facilitate on-line and off-line transactions at permissible merchants 370 or to conduct withdrawals of cash at ATMs until the pre-set spending capacity and or scheme has been reached.

Upon establishment of the second party card account 332, second party 350 may use the second party card account 332 to facilitate purchases of goods and/or services 372 or may access ATMs for cash (step 530) using known in the art systems and methods. After second party 350 uses the second party card account 332, administrator 330 provides a settling payment 338 to merchant 370 using any appropriate settlement procedures known in the art (step 532). In addition, administrator 330 prepares and issues a statement to first party 310 reflecting the activity of second party 350 using the second party card account 332 (step 534). In an exemplary embodiment, a typical statement generator and printer are utilized to produce a consolidated statement containing account and transaction data for both the first party account 315 and the second party card account 332. Finally, administrator 330 prepares and issues a statement to second party 350 reflecting the activity on the second party card account 332 for that cycle (step 536).

In the beginning of cycle, the first party account 315 is debited with the monthly budget allocated to the second party card account 332, and the second party card account 332 is credited with a corresponding value. Card account 332 usage is then permitted during the cycle up to the spending capacity to facilitate second party transactions such as spending or receiving goods and services at a merchant 370 or a withdrawal of cash at an ATM.

At the end of the cycle, the issuer provides a statement to first party 310. The statement includes the spending capacity (a.k.a. budget) that was allocated to second party 350 at the beginning of the cycle. Changes to the spending capacity are accomplished where, first, first party 310 desired to effect a change, second, communicates a request to the issuer (e.g., via telephone or on-line), third, the issuer approves the request, and fourth, implements the change.

At cycle cut, the system provides a billing statement reflecting the charges made by second party 350 to first party 310, either in a consolidated form with the statement for the first party account 315 or as a stand alone statement. Also, the system updates the spending capacity in accordance with the agreement with first party 310 (e.g., reflecting carry-over designations, charges made, payments made, interest accrued, adjustments to the spending capacity, and the like).

Once one or more second party card account 332 has been established, the charges for each second party card account 332 may be billed, for example, on a periodic (e.g., monthly) basis to, for example, the first party account 315 or a company's account or a predetermined bank account for direct payment. First party 310 may pay the charges on the second party card account 332 on a periodic (e.g., monthly) basis through any available funding vehicle (e.g., credit card, debit card, bank account, cash) or any combination thereof.

The system may also be configured to allow first party 310 to modify the spending capacities of the second party card account 332 or to cancel second party card account 332 altogether. In the event that first party 310 wishes to modify the spending capacity of second party card account 332, first party 310 may communicate a request to administrator 330 via facsimile, internet, telephone or other method known in the art (step 540). Once administrator 330 has received the request, administrator 330 may then modify the spending capacity of second party card account 332 in accordance with a predetermined allocation of risk (step 542), and may notify second party 350 of the modification (step 544) by facsimile, telephone, internet, e-mail, courier, standard mail or other means known in the art.

In addition, the system is configured to enable first party 310 to modify the pre-set spending capacity upon the request of first party 310. In situations where first party 310 would like to change spending capacities, or cancel card account 332, first party 310 communicates the request to the administrator via telephone call to a predefined telephone number or via online request. In response, administrator 330 approves the request and accomplishes the modification.

In accordance with an exemplary embodiment, the system facilitates the application and card account 332 establishment process. The system also tracks card account 332 usage and payments, and tracks the outstanding balance relative to the pre-set spending capacity. In accordance with this embodiment, the application and card account 332 establishment process begins when first party 310 and a potential second party apply for a card account 332 by transmitting application information to an administrator. The application information may include information identifying first party 310 (e.g., personal details regarding first party 310, account number of first party account 315), information identifying second party 350 (e.g., personal details regarding second party 350), information defining the desired characteristics of the second party card account 332 (e.g., desired spending capacity, allowable carry-over from cycle to cycle, limited or forbidden merchants 370, and the like), and acceptance of terms (e.g., agreement of responsibility).

In the event that first party 310 elects to cancel the first party account 315, administrator 330 will also cancel any second party account 332 linked to the cancelled account, unless first party 310 provides another form of security for the second party account 332. If the second party account 332 has a positive balance at the time it is cancelled, administrator 330 will refund the positive balance to first party 310. Administrator 330 is also configured to accommodate disputed transactions associated with second party card account 332 directly with second party 350. In the event first party 310 fails to remit payment to administrator 330 as promised, administrator 330 is configured to place a hold on account 332.

In an embodiment, the present invention can include an electronic prepaid funds card, akin to a gift card issued by credit card companies, but wherein the card's monetary goods/services value is available at predetermined time intervals (e.g., daily, unique dates, etc.).

As an example, regarding employee per diem, the employee's five-day business trip requires a daily per diem of $50 per day. Accordingly, the employee's prepaid funds card is loaded with $50 every 24-hours, commencing on the first day of the trip. Thus, the $250 per diem is never available in a lump sum.

In another example, regarding event concessions, a season ticket holder's package can include: (i) tickets for 20 games and (ii) $10 per game of prepaid funds card concessions. Accordingly, the season ticket holder's prepaid funds card is loaded with $10 on game day. The $200 concessions total is never available in one lump sum. Moreover, the funds card is only authorized to provide funds at concession stands at the event venue.

In an embodiment, the present invention can include an electronic prepaid funds card, akin to a gift card issued by credit card companies, but wherein scheduled balances, goods, services and cash that are not spent by the end of a business day or event are returned to the banking account of the employer or event sponsor, for example. Funds are not returned to the financial firm issuing the electronic prepaid funds card.

In an example, the business traveler has a 24-hour window to spend the daily per diem ($50) loaded onto the card. Every 24-hours, the employer makes available the funds only needed to top-off the card to $50.

In another example, the season ticket holder spends the $10 event balance. After each event, the sponsor makes available the funds needed to top-off the card to $10 for the next event.

As will be appreciated by those having ordinary skill in the art, among other things, the invention: (i) minimizes cash handling; (ii) enhances expense controls; (iii) reduces employee theft; (iv) ensures funds are used for stated purpose; and, (v) returns unused balances to employer or event sponsor.

In an example, a traveler has one week to use 1000 air miles. Every week, the airlines provide the air miles necessary to top off the card to 1000 air miles.

In an example, a student has one day to spend $10. Every day, the parent provides the moneys necessary to top off the card to $10.00.

In an example, a gift recipient has five days prior to and after five days after his/her birthday to spend $100. Moneys, goods, and services remaining after the 10 days period revert to the merchant sponsor and/or provider of the goods, services, and/or moneys.

In an example, an individual may have one hair cut every three weeks. Unused haircuts do not accumulate and revert to the provider of the service.

In an example, an individual may make 60 minutes of phone calls per day. Unused phone call minutes elapse and revert to the provider of the phone card.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography, please review a text written by Bruce Schneier, which is entitled “Applied Cryptography: Protocols, Algorithms, And Source Code In C,” published by John Wiley & Sons (second edition, 1996), which is hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

As will be appreciated by one of ordinary skill in the art, the present invention may be embodied as a method, a data processing system, a device for data processing, a device for card and check processing an integrated circuit, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CDROM, optical storage devices, magnetic storage devices, and/or the like.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create system and method for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of system and method for performing the specified functions, combinations of steps for performing the specified functions, and program instruction for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

In view of the many possible embodiments to which the principles of this invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

What is claimed is:

1. A method for facilitating the administration of a second party account comprising the steps of: establishing a second party prepaid account associated with a first party, establishing a second party spending capacity or scheme wherein said second party prepaid account is configured to consume at least part of said spending capacity or scheme to facilitate payment for a transaction; and establishing at least one spending limit configured to affect said spending capacity.

2. The method according to claim 1, wherein said spending or scheme limit is configured to affect a maximum transaction amount allowed per transaction.

3. The method according to claim 1, wherein said spending or scheme limit is configured to affect a maximum transaction amount allowed per day.

4. The method according to claim 1, wherein said spending limit is configured to affect a maximum transaction amount allowed during a predetermined time period.

5. The method according to claim 1, wherein said spending limit is configured to affect a maximum transaction amount allowed at a particular merchant.

6. The method according to claim 1, wherein said spending limit is configured to affect a maximum transaction amount allowed at a particular chain of merchants.

7. The method according to claim 1, wherein said spending limit is configured to affect a maximum transaction amount allowed at a particular industry type.

8. The method according to claim 1, wherein said spending capacity is determined by the amount of funds loaded onto the second party prepaid account by the first party.

9. The method according to claim 8, wherein the first party can withdrawn funds loaded on the second party prepaid account.

10. A system for administering a second party account having a second party spending capacity; the system comprising an account administrator in communication with a transaction administrator, a settler, and a statement generator; the account administrator configured to facilitate the establishment of one or more second party accounts and to establish at least one spending limit configured to affect said spending capacity, the transaction administrator configured to facilitate transactions, the settler configured to facilitate providing a settling payment to a merchant, the statement generator configured to facilitate generating a first party account statement.

11. The method according to claim 10, wherein said spending limit is configured to affect a maximum transaction amount allowed per transaction.

12. The method according to claim 10, wherein said spending limit is configured to affect a maximum transaction amount allowed per day.

13. The method according to claim 10, wherein said spending limit is configured to affect a maximum transaction amount allowed during a predetermined time period.

14. The method according to claim 10, wherein said spending limit is configured to affect a maximum transaction amount allowed at a particular merchant.

15. The method according to claim 10, wherein said spending limit is configured to affect a maximum transaction amount allowed at a particular chain of merchants.

16. The method according to claim 10, wherein said spending limit is configured to affect a maximum transaction amount allowed at a particular industry type.

17. The method according to claim 10, wherein said spending capacity is determined by the amount of funds, goods, award points and services loaded onto the second party prepaid account by the first party.

18. The method according to claim 17, wherein the first party can withdrawn funds loaded on the second party prepaid account.
